(19) United States
(12) Patent Application Publication
(10) Pub. No.: US 2018/0328488 A1
(43) Pub. Date: Nov. 15, 2018

(54) COUPLING OF A GEARSHIFT AND A SHIFT OPERATION

(71) Applicant: GM GLOBAL TECHNOLOGY OPERATIONS LLC, Detroit, MI (US)

(72) Inventor: Sascha Schlieker, Hattersheim (DE)

(73) Assignee: GM GLOBAL TECHNOLOGY OPERATIONS LLC, Detroit, MI (US)

(21) Appl. No.: 15/976,511

(22) Filed: May 10, 2018

(30) Foreign Application Priority Data
May 10, 2017 (DE) 102017004474.0

(51) Int. Cl. F16H 63/30; F16H 59/02; F16H 61/36

(52) U.S. Cl. CPC F16H 63/30; F16H 59/0278; F16H 2306/40; F16H 2059/0221; F16H 61/36

(57) ABSTRACT

A coupling arrangement is disclosed for coupling a gearshift and a shift operator with a selector shaft for a manual transmission of a motor vehicle. The coupling arrangement has a transmission member with a first section on the gearshift side and a second section on the selector shaft side. The transmission member is displaceably mounted by a guide and is deflected by at least 45°.

### CROSS-REFERENCE TO RELATED APPLICATION

This application claims priority to German Patent Application No. 102017004474.0, filed May 10, 2017, which is incorporated herein by reference in its entirety.

### TECHNICAL FIELD

The present disclosure pertains to a coupling arrangement for coupling a gearshift and a shift operator with a selector shaft for a manual transmission, a motor vehicle with the coupling arrangement and a method for adjusting a shift operator with a selector shaft by operating a gearshift using the coupling arrangement.

### BACKGROUND

EP 1 122 468 A1 discloses a switching device for a motor vehicle having a manual gearshift, which is mounted in a ball joint bearing. A lever arm is connected in a joint with a pivotally mounted angle lever on which in a further joint to which a Bowden cable transmitting a gear selection movement is attached.

DE 10 2016 201 551 A1 discloses a switching device for a vehicle with a manual gearshift, which is mounted in a universal joint bearing device and has a lever arm in the form of a bolt, which is connected in a joint to a pivotally mounted (angle) lever on which a cable is attached for transmitting a gear selection movement.

### SUMMARY

According to an embodiment of the present disclosure, a coupling arrangement, having a gearshift and an inner shift operator with a selector shaft for a manual transmission are coupled. The coupling arrangement includes a transmission member with a first section on the gearshift side and a second section on the selector shaft side. The transmission member is displaceably mounted in a guide between the first and second section. The guide is deflected by at least 45°, in one embodiment at least 60°, in particular at least 75°, in particular at least 85°. In one embodiment, a movement direction in which the first section is displaceably mounted by the guide and a movement direction in which the second section is displaceably mounted by the guide such that the guide forms or includes an angle with each other in a range between 45° and 135°, in one embodiment in a range between 60° and 120°, in particular in a range between 75° and 105°, in particular in a range between 85° and 95°, that is, in particular, at least substantially perpendicular.

As a result, in an embodiment, a structure, a manufacturing, an assembly and/or a function, in particular translation, of the coupling of the gearshift and shift operator, in particular selector shaft, are improved, costs and constructed space are reduced, design freedom, translation uniformity and precision are increased, and clearance is reduced. In an embodiment, the angle lever, which in the above-referenced patent publications is necessary for implementing a predominantly vehicle transverse axis parallel movement of a shaft of the gearshift in a predominantly vehicle longitudinal axis parallel movement of the Bowden cable or cable, can be omitted. Additionally or alternatively, in an embodiment, a movement direction of the gearshift, in particular a shaft or lever arm of the gearshift, can advantageously be implemented into a movement direction inclined relative to this movement direction or a plane to actuate the selector shaft. In an embodiment, a movement direction of an articulation point, which is fixed to the gearshift or on the gearshift side, on which the transmission is attached, is predominantly parallel to a vehicle vertical or transverse axis in a movement direction of a cable. In particular, a Bowden cable, a switch rod or the like is predominantly parallel to a vehicle longitudinal axis, so as to advantageously operate a manual transmission spaced from the gearshift in the direction of the vehicle longitudinal axis.

The gearshift may be operated manually in an embodiment or provided for this purpose. The manual gearshift can be pivotally mounted in one or more parts by a bearing, in particular a ball or universal joint bearing, for selecting or pre-selecting or shifting gears of the manual transmission on a base provided for this purpose. In one embodiment, the manual gearshift has an operating shaft and a lever arm parallel or rotating about at least one common axis with this, at which or the articulation point of which the first section may be attached is provided for this purpose.

The lever arm protrudes in an embodiment transversely from the operating shaft of the gearshift such that it or a lever arm-side articulation point of the gearshift, on which the first section is attached executes offset or rotated movement by at least 45°, in particular by at least substantially, 90° during a movement of the shaft. In other words, the lever arm implements a movement of the shaft predominantly parallel to a vehicle transverse axis in a movement of the lever arm or articulation point predominantly parallel to a vehicle vertical axis.

In another embodiment, the lever arm is articulated, connected to the operating shaft of the gearshift, such that the lever arm or a lever arm-side articulation point of the gearshift to which the first section is attached, which a rotation of the shaft about an axis, executes a movement parallel to this about this axis, and therefore implements a movement of the shaft predominantly parallel to a vehicle transverse axis in a movement of the lever arm or articulation point also predominantly parallel to a vehicle transverse axis.

The lever arm is, in an embodiment, connected to the operating shaft of the gearshift non-destructively detachably or positively, frictionally engaged and/or firmly bonded. The lever arm is used in a development also for the universal joint bearing of the gearshift, in particular for its bearing rotatable about a switch selection axis or shift operator axis.

The selector shaft is axially displaced in an embodiment by the gearshift coupled thereto by the coupling arrangement for selecting or pre-selecting gears and/or is twisted for switching, engaging and/or releasing selected gears. In an embodiment, the first and second sections are connected by a connecting section which the guide deflects or is configured for this purpose. In a development, the connecting section and the first and/or second section are integrally formed with each other. As a result, weight and/or strength can be improved in an embodiment.

In an embodiment, the connecting section and the first section and/or the connecting section and the second section are made separately from each other and are rigid or articulated and/or non-destructively detachably or connected with each other positively, frictionally engaged and/or firmly bonded. Additionally or alternatively, in an embodiment, the first and/or second section are configured rod-shaped and/or resistant to pulling, pressure and/or bending. As a result, in one embodiment, the transmission, deflection and/or assembly can be improved.

In an embodiment, the connecting section has a traction device, and more particularly a chain or articulated member, which bends or is soft or slack so as to not transmit bending torques at least in the deflection direction. As a result, the transmission, deflection and/or assembly can be improved.

In an embodiment, the guide, and in particular its first section, second section and/or connecting section, at least partially surrounds or encloses the traction device. In a further development, the guide is at least partially open or slotted, or at least partially closed or channeled a in the circumferential direction such that it is resistant to pulling, pressure or bending, at least in the region of the deflection or the connecting section and/or in the deflection, in particular a closure or articulated closure. In an embodiment the guide is according to amount bent or turned by at least 45°, in an embodiment by at least 60°, in particular by at least 75°, and more particularly by at least 85°. As a result, in one embodiment, the transmission, deflection and/or assembly can be improved.

In an embodiment, the guide is supported in at least one selector shaft-side abutment, which may be attached on the base in a non-destructively detachably manner or a positively, frictionally engaged and/or firmly bonded manner, on which the gearshift is articulated mounted. As a result, in one embodiment, the transmission, deflection and/or assembly can be improved.

In an embodiment, the first section or an interface of the first section with the gearshift set up for this purpose, such as its lever arm, is connected via a joint in a non-destructively detachably manner or a positively, frictionally engaged and/or firmly bonded manner provided for this purpose. In an embodiment, this joint has a pin arranged rotatable and/or displaceably in a groove. As a result, in an embodiment, the transmission, deflection and/or assembly can be improved. In particular, the first section can be hinged or articulated or attached to the gearshift or an articulation point of a lever arm of the gearshift.

In an embodiment, the second section or an interface of the second section is connected to a cable, in particular a Bowden cable, and/or a switch rod of a shift linkage for actuating the shift operator with the selector shaft in a rigidly or articulated manner or a non-destructively detachably manner or a particular positively, frictionally engaged or firmly bonded manner. As a result, in an embodiment, the transmission, deflection and/or assembly can be improved. In particular, the second section can be connected to a previously used cable or a previously used switch rod.

In an embodiment, the coupling arrangement is set up for this or such that a pulling movement of the first section away from the guide, in particular possibly further out of the guide, is implemented in a pulling movement of the cable or the switch rod away from the selector shaft or shift operator and/or an insertion movement of the first section towards the guide, in particular deeper into the guide, is implemented in a pushing movement of the cable or the switch rod to the selector shaft or shift operator.

In one embodiment, the coupling arrangement is reversed or set up such that a pulling movement of the first section away from the guide, in particular further out of the guide, is implemented in a pushing movement of the cable or the switch rod to the selector shaft or shift operator and/or an insertion movement of the first section towards the guide, in particular deeper into the guide, is implemented in a pulling movement of the cable or the switch rod from the selector shaft or shift operator. As a result, a movement of the gearshift can be selectively transmitted either in the same or opposite directions.

In one embodiment, the coupling arrangement is set up such that an operating movement of the first section and/or a lever arm of the gearshift connected thereto is implemented into a corresponding operating movement of the second section, which is angled against the operating movement according to amount by at least 45°, in an embodiment by at least 60°, in particular by at least 75°, and in particular by at least 85°.

As a result, in an embodiment, a structure, a manufacturing, an assembly and/or a translation of the coupling of the gearshift and shift operator and/or selector shaft are improved, costs and/or constructed space are reduced, design freedom, translation uniformity and/or precision are increased, and clearance is reduced. As a result, the angle lever, used in conventional coupling arrangements for implementing a predominantly vehicle transverse axis parallel movement of a shaft of the gearshift in a predominantly vehicle longitudinal axis parallel movement of the Bowden cable is omitted. Additionally or alternatively, in an embodiment, a movement direction of the gearshift, in particular a shaft or lever arm of the gearshift, can advantageously be implemented into a movement direction inclined relative to this movement direction or plane to actuate the selector shaft. In an embodiment, a movement direction of an articulation point, which is fixed to the gearshift or on the gearshift side, is predominantly parallel to a vehicle vertical or transverse axis in a movement direction of a cable, in particular a Bowden cable, a switch rod or the like predominantly parallel to a vehicle longitudinal axis, so as to advantageously operate a manual transmission spaced from the gearshift in the direction of the vehicle longitudinal axis.

The coupling arrangement is used with particular advantage for transmitting a gear pre-selection or selection operating movement of the first section or gearshift or its lever arm, to which an operating shaft of the gearshift usually predominantly parallel to a vehicle transverse axis or predominantly is pivoted about a vehicle longitudinal axis.

Accordingly, in an embodiment, the first section is displaceable by the guide predominantly parallel to a vehicle vertical or transverse axis and/or the second section is displaceably mounted by the guide predominantly parallel to a vehicle longitudinal axis. Similarly, in an embodiment, it can also be used to transmit a gearshift motion to engage or release selected gears.

For adjusting the shift operator, in particular the selector shaft, by operating the gearshift with the coupling arrangement, according to an embodiment of the present disclosure, an operation of the gearshift is implemented by the coupling arrangement into an actuating movement of the second section, which is angled against a plane of this operation according to amount by at least 45°, in one embodiment by at least 60°, in particular by at least 75°, in particular by at least 85°.

### BRIEF DESCRIPTION OF THE DRAWINGS

The present disclosure will hereinafter be described in conjunction with the following drawing figures, wherein like numerals denote like elements.

FIG. 1 shows a system having a manual transmission and a coupling arrangement according to an embodiment of the present disclosure in a first gear selection position;

FIG. 2 shows the system having the coupling arrangement in a second gear selection position;

FIG. 3 shows a system with a manual transmission and a coupling arrangement according to a further embodiment of the present disclosure in FIG. 1 corresponding representation;

FIG. 4 shows a system with a manual transmission and a coupling arrangement according to a further embodiment of the present disclosure in FIG. 1 corresponding representation; and

FIG. 5 shows a part of a system having a coupling arrangement according to a further embodiment of the present disclosure in perspective view.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

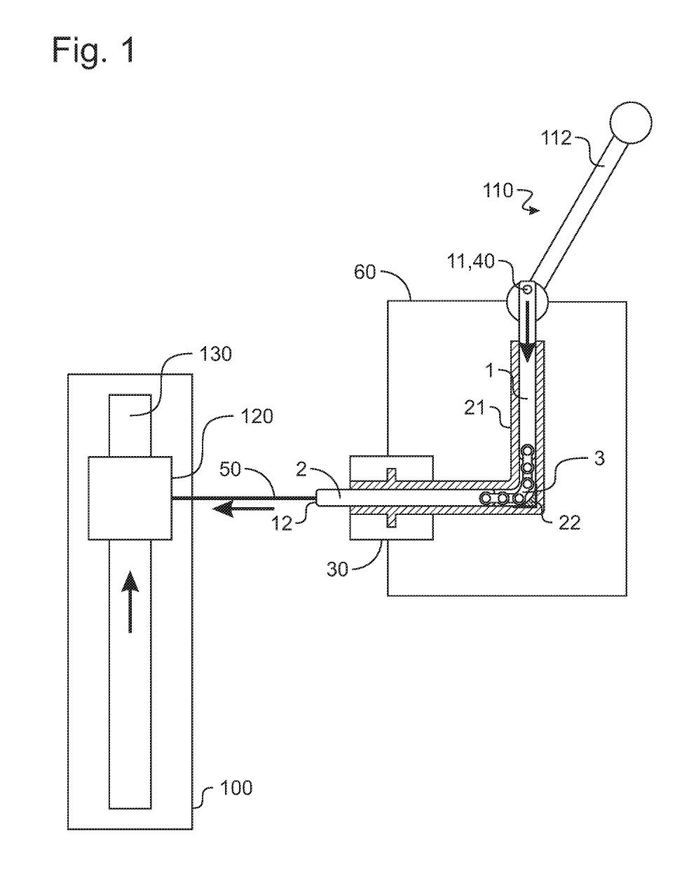

FIG. 1 shows a system having a manual transmission 100 and a coupling arrangement according to an embodiment of the present disclosure in a first gear selection position. The coupling arrangement couples a gearshift 110 and a shift operator 120 with a selector shaft 130 for the manual transmission 100.

For this purpose, the coupling arrangement has a transmission member with a gearshift-side first section in the form of a first rod 1, a selector shaft-side second section in the form of a second rod 2 and a connecting section connecting them in the form of an articulated chain 3 and a guide in the form of a channel 21 angled at 90° with a deflection element 22, by which the transmission member 1-3 is displaceably mounted and deflected by 90°. The guide 21, 22 is supported in a selector shaft-side abutment 30 which is attached to a base 60, on which the gearshift 110 is mounted articulated.

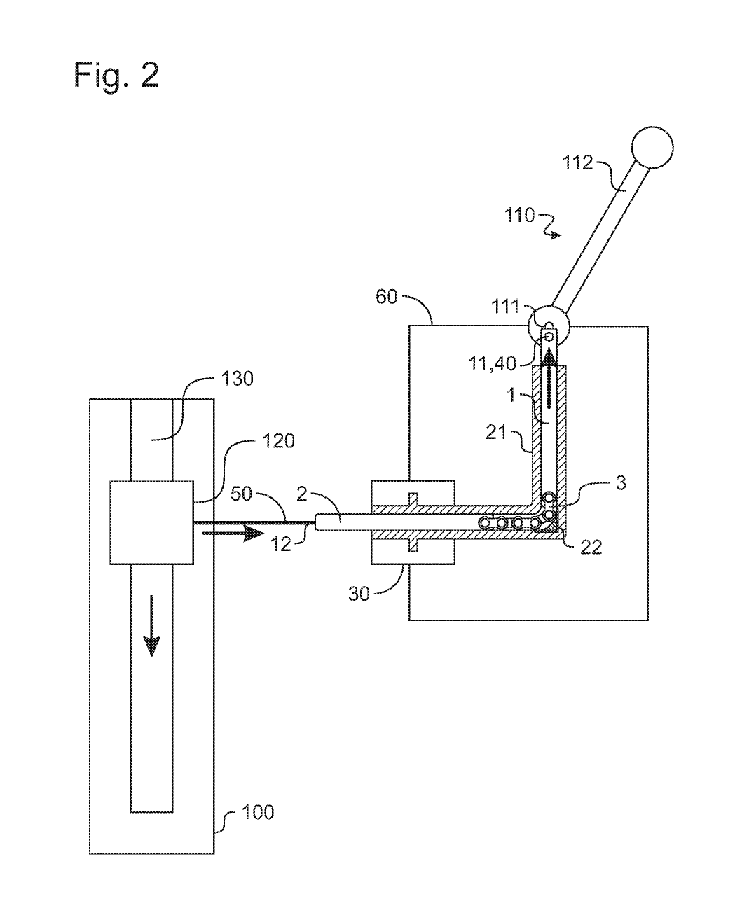

An interface 11 of the first section 1 is connected to a lever arm 111 (see FIG. 2) of the gearshift 110 in a joint 40 non-destructively detachably connected. An interface 12 of the second section 2 is connected to a cable 50 of a Bowden cable or in a modification with a switch rod of a shift linkage for actuating the inner shift operator 120 or the selector shaft 130.

As seen by the sequence illustrated from FIG. 2 to FIG. 1 and the movement arrows indicate in FIG. 2, the coupling arrangement implements a gear pre-selection or selection operating movement of the gearshift 110 and an accompanying pulling out movement of the first section 1 further out of the guide 21 in a pulling away movement of the Bowden cable 50 or the switch rod from the selector shaft 100 or shift operator 120 to the right in FIG. 2, and vice versa (see FIG. 1 to FIG. 2 and movement arrows in FIG. 1) an opposing gear pre-selection or selection operating movement of the gearshift 110 or an accompanying insertion of the first section 1 deeper in the guide 21 in a pushing movement of the Bowden cable 50 or the switch rod to the selector shaft 100 or shift operator 120 to the left.

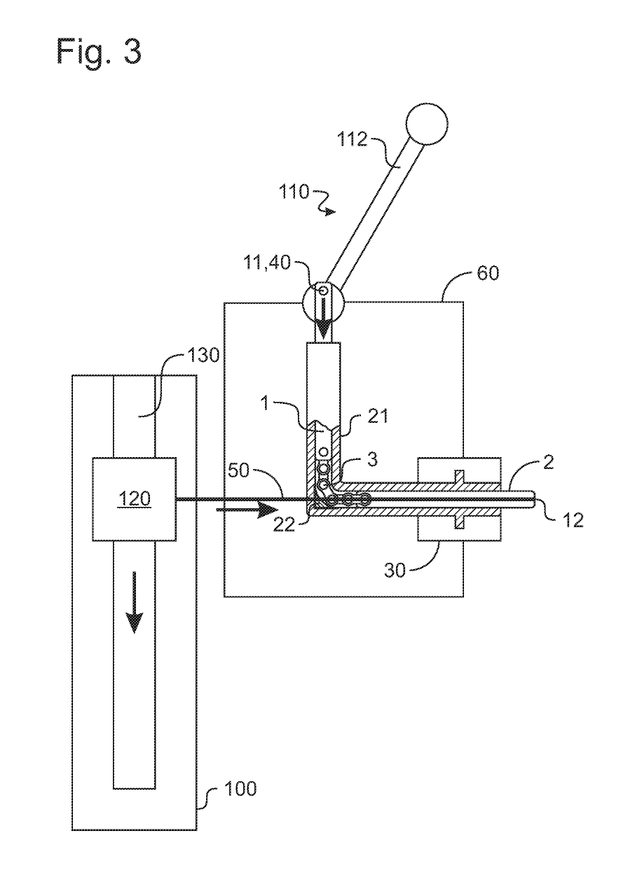

In another embodiment, shown in FIG. 3, which otherwise corresponds to the embodiment of FIGS. 1 and 2 and to which reference is therefore made to the description thereof, the coupling arrangement conversely implements a pulling out movement of the first section 1 further out of the guide 21 in a pushing movement of the cable 50 or the switch rod to the selector shaft 100 or shift operator 120 to the left, and vice versa (see movement arrows in FIG. 3) an insertion movement of the first section 1 deeper into the guide 21 in a pushing movement of the cable 50 or the switch rod to the selector shaft 100 or shift operator 120 to the left.

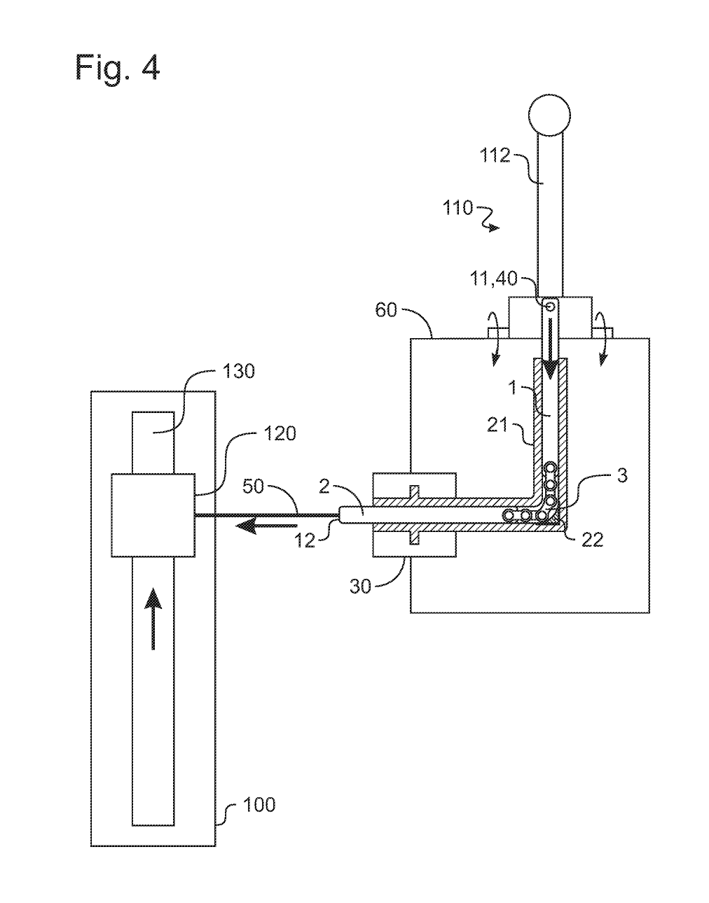

FIG. 4 shows in FIG. 1 corresponding representation of a system having a coupling arrangement according to a further embodiment of the present disclosure in a first gear selection position. Corresponding features are again identified by identical reference numerals, so that reference is made to the preceding description of the embodiments of FIGS. 1-3 and only differences are discussed in the following.

In the embodiment of FIG. 4, as indicated by rotation arrows, the gearshift 110 is mounted in a universal joint on the base 60 by its lever arm, to which the interface 11 of the first section 1 is connected in the joint 40 non-destructively detachably, to the explanation of which reference is additionally made to the already mentioned DE 10 2016 201 551 A1. By the movement of the gearshift 110 or its shaft 112, as indicated by the rotation arrows, a gear can again be selected, a gear is engaged or released by a pivoting movement perpendicular thereto about the longitudinal axis of the lever arm.

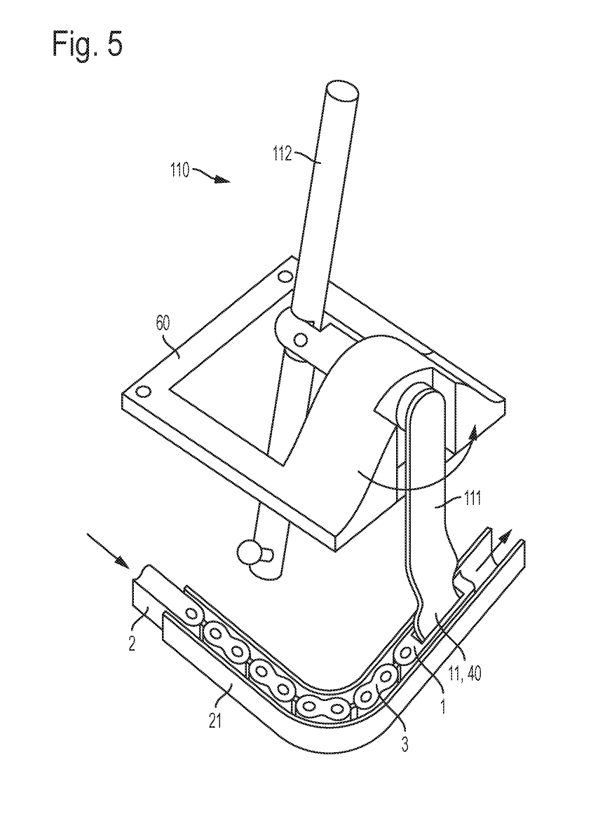

FIG. 5 shows a perspective view of part of a system having a coupling arrangement according to a further embodiment of the present disclosure. Corresponding features are again identified by identical reference numerals, so that reference is made to the preceding description of the embodiments of FIGS. 1-4 and only differences are discussed in the following.

In the embodiment of FIG. 5, the gearshift 110 is likewise mounted in a universal joint on the base 60 by its lever arm 111, with which the interface 11 of the first section 1 in the joint 40 is non-destructively detachably connected. A gear can in turn be selected by the movement of the gearshift 110 or its shaft 112 or with this rotating lever arm 111 indicated by the rotary arrow.

Although exemplary embodiments have been explained in the foregoing description, it should be understood that a plurality of modifications is possible. Thus, in particular also in the embodiment with universal joint bearing of FIG. 4, the coupling arrangement implements a pulling out movement of the first section 1 further from the guide 21 in a pushing movement of the cable 50 or the switch rod to the selector shaft 100 or shift operator 120 to the left as explained with reference to FIG. 3.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-13. (canceled)

14. A coupling arrangement for coupling a gearshift and a shift operator with a selector shaft for a manual transmission of a motor vehicle comprising a transmission member having a first section on the gearshift side and a second section on the selector shaft side, wherein the transmission member is displaceably mounted by a guide such that the second member is deflected by at least 45° with respect to the first member.

15. The coupling arrangement according to claim 14, further comprising a connecting section interconnecting the first and second sections, wherein the connecting section is deflected by the guide.

16. The coupling arrangement according to claim 15, wherein the connecting section comprises a traction member.

17. The coupling arrangement according to claim 16, wherein the traction member comprises an articulated chain.

18. The coupling arrangement according to claim 14, wherein the guide at least partially surrounds the transmission member.

19. The coupling arrangement according to claim 14, wherein the guide is supported in at least one abutment.

20. The coupling arrangement according to claim 14, wherein the first section comprises a first interface configured to connect the transmission member to the gearshift at a joint.

21. The coupling arrangement according to claim 20, wherein the second section comprises a second interface configured to connect to a cable.

22. The coupling arrangement according to claim 14, wherein the coupling arrangement is operable to implement a pulling movement of the first section of the guide away in a pulling movement of the cable.

23. The coupling arrangement according to claim 14, wherein the coupling arrangement is operable to implement an operating movement of the first section yielding a corresponding actuating movement of the second section, which is angled against the operating movement by at least 45°.

24. The coupling arrangement according to claim 23, wherein the operating movement is a gear selection or gear shift movement.

25. A system for a motor vehicle having a manual transmission comprising:
a gearshift;
a shift operator with a selector shaft for shifting gears of the manual transmission; and
a coupling arrangement including a transmission member having a first section on operably coupled to the gearshift, a second section operably coupled to the shift operator and a guide displaceably mounting the second member in a deflected position with respect to the first member by at least 45°.

26. A motor vehicle according to claim 25, wherein the first section is displaceably mounted by the guide predominantly parallel to a first axis predominantly perpendicular to a vehicle longitudinal axis and the second section is displaceably mounted by the guide predominantly parallel to the vehicle longitudinal axis.
